(19) United States
(12) Patent Application Publication
(10) Pub. No.: US 2005/0084195 A1
(43) Pub. Date: Apr. 21, 2005

(54) Method and apparatus for forming lateral electrical contacts for photonic crystal devices

(76) Inventors: Hendrik F. Hamann, Yorktown Heights, NY (US); Sharee J. McNab, Katonah, NY (US); Yurii A. Vlasov, Katonah, NY (US)

Correspondence Address: Moser, Patterson & Sheridan, Suite 100, 595 Shrewsbury Avenue, Shrewsbury, NJ, 07702, US

(21) Appl. No.: 10/686,216

(22) Filed: Oct. 15, 2003

(51) Int. Cl. G02F 1/035; G02F 1/295

(52) U.S. Cl. 385/2; 385/5; 385/8; 385/40

(57) ABSTRACT

The present invention is a method an apparatus for forming lateral electrical contacts for photonic crystal based structures. In one embodiment, a photonic crystal structure comprises a substrate having a plurality of apertures formed therethrough, a waveguide formed by “removing” a row of apertures, and a pair of lateral electrical contacts, each spaced a distance away from the waveguide by at least one row of apertures. The optical mode of the waveguide is confined in the lateral direction by the at least one row of apertures. Thus the apertures provide optical isolation for the electrical contacts, which minimizes losses due to absorption of light by the contacts. The contacts may be used to apply voltages for thermo-optic control of the waveguide, for current injection, or for configuring the waveguide as a photodetector, among other applications.

### BACKGROUND

The invention relates generally to photonic crystals, and relates more particularly to electrical contacts for photonic crystal devices. Specifically, the present invention relates to a method and apparatus for forming lateral electrical contacts for photonic crystal devices.

Photonic crystal based structures possess a number of unique properties that may be useful as building blocks in photonic integrated circuits (PICS). The ability of photonic crystals to confine light down to scales in the order of a wavelength, as well as low-loss, sharp bends, suggests their suitability for waveguides that can be utilized for compact optical devices. Another notable attribute of photonic crystals is their unique tunable dispersion, which may be exploited to “slow” the velocity of light for interference based devices, such as switches.

The material systems most suitable for photonic crystal devices are those that have a large refractive index contrast (e.g., silicon, gallium arsenide, germanium) and a low absorption coefficient, as these materials produce a large photonic band-gap. Conveniently, many suitable photonic crystal materials may also function as semiconductor materials, making opto-electronic integration a natural fit. There are many ways to achieve opto-electronic interactions; the most efficient method depends heavily on the properties of the material and the nature of the device. Mechanisms to induce an optical change from an electronic input include changing the refractive index by application of an electric field, injecting carriers, or thermo-optic effects. These interactions commonly require electrical contacts to be placed in the vicinity of the optical device. For example, contacts to apply a voltage to induce resistive heating in a waveguide, or contacts to allow current injection into a resonant cavity, must be placed near the optical device in order to function effectively.

To date, it has proven extremely difficult to combine electronic control with high refractive index, high confinement systems without distorting the optical field and inducing unwanted absorption. Thus efforts to integrate electronic control with photonic crystal devices are confronted with two competing concerns: (1) the need to place the electrical contacts as close to the optical mode as possible to achieve optimal control; and (2) the need to space the electrical contacts far enough away from the optical mode to minimize distortion and absorption.

Thus, there is a need for a method and apparatus for forming lateral electrical contacts for photonic crystal based structures.

### SUMMARY OF THE INVENTION

The present invention is a method and an apparatus for forming lateral electrical contacts for photonic crystal based structures. In one embodiment, a photonic crystal structure comprises a substrate having a plurality of apertures formed therethrough, a waveguide formed by “removing” a row of apertures, and a pair of lateral electrical contacts, each contact spaced a distance away from the waveguide by at least one row of apertures. The optical mode of the optical signal within the waveguide is confined in the lateral direction by at least one row of apertures. Thus the apertures provide optical isolation for the electrical contacts, and the optical isolation minimizes losses due to absorption of the optical signal by the contacts. The contacts may be used to apply voltages for thermo-optic control of the waveguide, for current injection, or for configuring the waveguide as a photodetector, among other applications.

### BRIEF DESCRIPTION OF THE DRAWINGS

So that the manner in which the above recited embodiments of the invention are attained and can be understood in detail, a more particular description of the invention, briefly summarized above, may be had by reference to the embodiments thereof which are illustrated in the appended drawings. It is to be noted, however, that the appended drawings illustrate only typical embodiments of this invention and are therefore not to be considered limiting of its scope, for the invention may admit to other equally effective embodiments.

FIG. 1 illustrates a top plan view of one embodiment of a photonic crystal structure with lateral contacts according to the present invention;

FIG. 2 illustrates a cross-sectional view of the photonic crystal structure illustrated in FIG. 1;

FIG. 3 illustrates a top plan view of the optical power distribution for photons passing through a photonic crystal structure such as that illustrated in FIGS. 1 and 2;

FIG. 4 illustrates a cross sectional view of the optical power distribution through a photonic crystal structure illustrated in FIG. 3;

FIG. 5 illustrates another embodiment of a photonic crystal structure according to the present invention, in which the contacts are oppositely doped;

FIG. 6 illustrates another embodiment of a photonic crystal device in which the device is constructed as a resonant cavity;

FIG. 7 illustrates a cross sectional view of the photonic crystal device illustrated in FIG. 6;

FIG. 8 illustrates another embodiment of a photonic crystal device in which apertures are formed in the lateral electrical contacts;

FIG. 9 illustrates a cross sectional view of the photonic crystal device illustrated in FIG. 8;

FIG. 10 illustrates a plan view of one embodiment of a three-dimensional photonic crystal structure incorporating lateral electrical contacts; and

FIG. 11 illustrates a schematic view of the voltage contour lines for one embodiment of a photonic crystal device according to the present invention.

To facilitate understanding, identical reference numerals have been used, where possible, to designate identical elements that are common to the figures.

### DETAILED DESCRIPTION

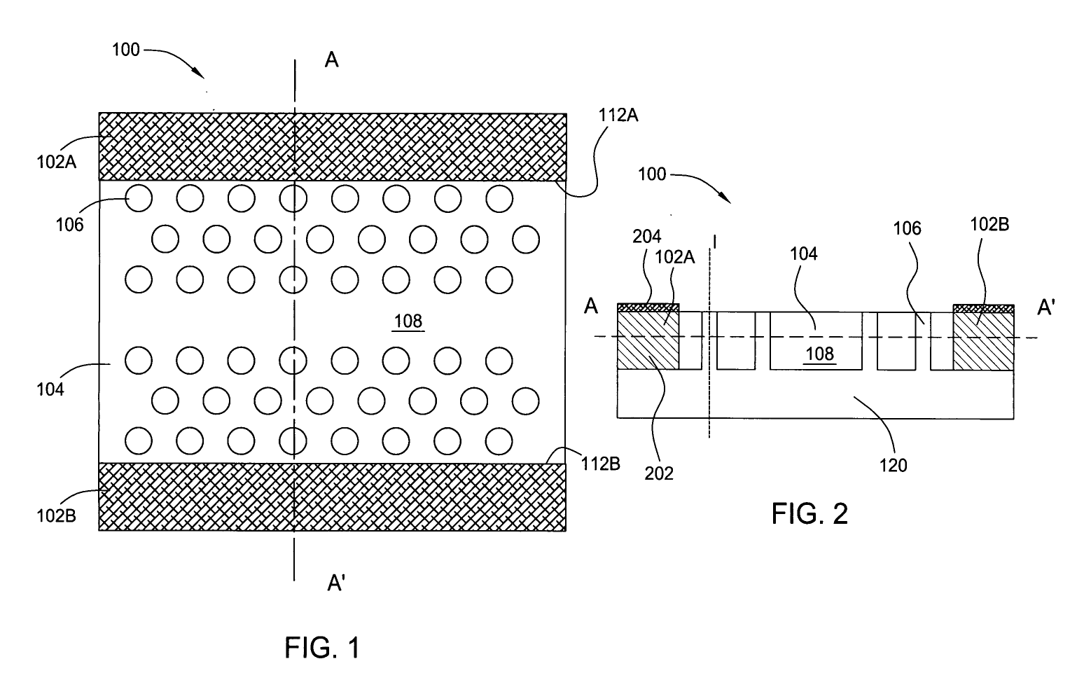

FIG. 1 is a top plan view of one embodiment of a two-dimensional photonic crystal structure 100 with lateral contacts 102a and 102b (hereinafter collectively referred to as “contacts 102”) according to the present invention. The photonic crystal structure 100 comprises a substrate 104, a plurality of apertures 106 formed in the substrate 104, a waveguide 108, and first and second lateral electrical contacts 102a and 102b. As illustrated in FIG. 2, which is a cross-sectional view of the photonic crystal structure 100 taken along line A-A′ of FIG. 1, the apertures 106 extend substantially completely through the substrate 104 (i.e., like channels) to an optical isolation layer 120, and the apertures 106 are arranged in rows to form a periodic lattice. The waveguide 108 is positioned to form a sort of channel through the lattice structure, with several rows of apertures 106 extending outward from the longitudinal edges of the waveguide 108. The first electrical contact 102a is positioned proximate to the waveguide 108, and in one embodiment the first electrical contact 102a is positioned proximate to a first edge 112a of the substrate 104, substantially parallel to the waveguide 108 and spaced apart therefrom by a plurality of apertures 106. The second electrical contact 102b also positioned proximate to the waveguide 108, and in one embodiment the second electrical contact 102b is positioned proximate to a second edge 112b of the substrate 104 opposite to the first edge 112a, also substantially parallel to the waveguide 108 and spaced apart therefrom by a plurality of apertures 106. The optical isolation layer may comprise any suitable optical isolation material including, but not limited to, air or silicon dioxide.

In one embodiment, the substrate 104 is formed from a high refractive index material. The magnitude of the refractive index is a relative value; i.e., the substrate material 104 has a high refractive index relative to the refractive indices of the apertures 106, and in one embodiment, the refractive index contrast is greater than 1:1. Suitable high refractive index materials include, but are not limited to, Group IV materials (including silicon, carbon, germanium and alloys thereof, among others), Group III-VI materials (including gallium arsenide, gallium phosphide, indium phosphide, indium arsenide, indium antimonide, and alloys thereof, among others), and Group II-IV materials (including zinc oxide, zinc sulfide, cadmium sulfide, cadmium selenide, cadmium tellurium, and alloys thereof, among others). Forms of silicon that may be used include single crystalline, polycrystalline and amorphous forms of silicon, among others. Polysilicon or amorphous silicon may be particularly advantageous for applications where cost and ease of fabrication and process integration are concerns. In addition, metals such as aluminum, tungsten, gold, silver and palladium, among others, as well as semiconductors may be used to advantage.

In one embodiment, the photonic crystal structure 100 is part of an optical delay line. In another embodiment, the photonic crystal structure 100 is part of an optical modulator. Although the embodiment illustrated in FIG. 1 depicts a two-dimensional photonic structure 100, those skilled in the art will appreciate that the present invention may also be incorporated into one- or three-dimensional photonic crystal structures as well.

The waveguide 108 has a refractive index that substantially matches the refractive index of the substrate 104, and therefore may be formed by “removing” a row of apertures 106. In one embodiment, this is accomplished by filling a row of apertures 106 with a material having a refractive index that substantially matches that of the substrate 104. In the lateral direction (i.e., substantially perpendicular to the longitudinal axes l of the apertures 106), light is confined to the waveguide region by Bragg scattering. In the vertical direction (i.e., substantially parallel to the longitudinal axes l of the apertures 106), light is confined in the waveguide region by total internal reflection (TIR). Thus it is possible to confine light within the cross-section of the waveguide 108 with very low lateral field extent.

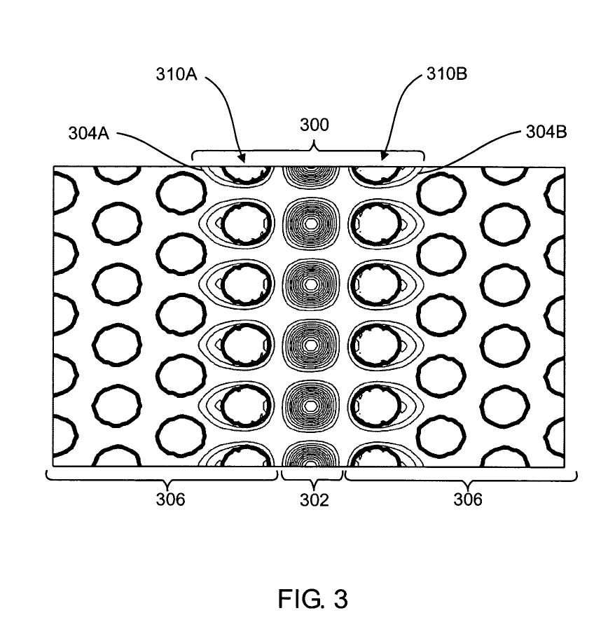

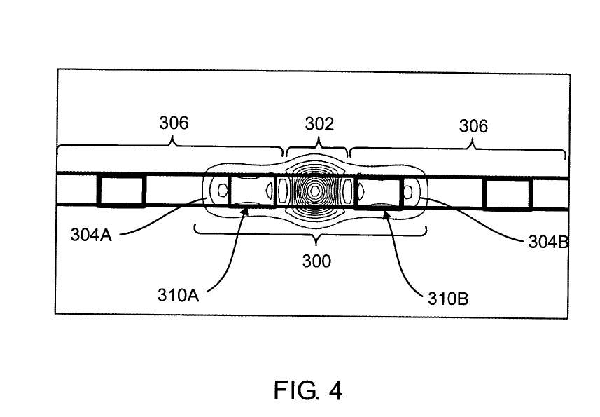

FIG. 3 is a top plan view illustrating the optical power distribution, or “optical mode” 300, for photons passing through a waveguide 302 such as that illustrated in FIGS. 1 and 2. As illustrated, the majority of the optical mode 300 is confined within the waveguide region as described above. The “tails” 304a and 304b, or the furthest reaching (laterally) edges of the optical mode 300, extend only a few rows into the periodic lattice 306. In the embodiment illustrated in FIG. 3 and in FIG. 4, which is a cross sectional illustration of the waveguide 302 illustrated in FIG. 3, the tails 304a and 304b reach only one row 310a or 310b outward from the waveguide region. Typically, the field intensity of the optical mode will decay exponentially as it expands laterally outward into the periodic lattice 306. For example, the evanescent magnetic field is described by the relationship
H(r)=u(r)e^{i(k+iκ)x}
where H(r) is the magnetic field vector, u(r) is a periodic function describing the photonic crystal and k+iκ is the complex wave vector. The pre-factor for the decay rate κ is dependent on the effective refractive index, which is a function of the refractive index contrast of the photonic crystal structure 100, the photonic crystal geometry and the mode in consideration.

Only a few rows of apertures 106 are therefore necessary to substantially confine light laterally in the waveguide region and optically isolate the contacts 102. For example, FIG. 11 is a schematic illustration of the voltage contour lines between two lateral electrical contacts 1102a and 1102b that are positioned on either side of a substrate 1104. In the embodiment illustrated in FIG. 11, four rows of apertures 1106 are employed on either side of a two-dimensional waveguide 1108, and a five Volt potential is applied across the waveguide 1108. Equipotential surfaces 1110 are illustrated by gray lines. In the embodiment illustrated, the substrate 1104 is a 220 nm thick silicon slab, the apertures each have a diameter of 315 nm, and the lattice constant, a, is 450 nm. The five Volt potential generates an electric field strength in the region of the waveguide 1108 that is on the order of 5×10⁵ V/m, and generates current densities of up to approximately 2×10⁷ A/m². As illustrated in FIGS. 3 and 4, a structure such as that illustrated is capable of substantially confining light within the waveguide region, thereby substantially minimizing absorption in the contact region. At the same time, the electric field strength and the current density generated by the contacts are high enough to change the refractive index of the photonic crystal structure, or inject or collect carriers in the central waveguide region.

Thus, referring back to FIGS. 1 and 2, the electrical contacts 102 may be placed fairly close to the waveguide 108, without disturbing the optical field of light within the waveguide region. This ensures that there will be minimal absorption losses, even if the contacts 102 are formed from a metal or other materials with high absorption losses (e.g., doped semiconductors). Furthermore, as illustrated in FIG. 2, this allows the electrically contacts 102 to be positioned laterally, i.e., on at least the same layer of a photonic crystal device 100 as the light passing therethrough. In other words, the contacts 102 are laterally positioned, at least, on a layer where the light is guided (e.g., where the waveguide 108 is deployed). The deployment of lateral contacts 102 marks a significant advancement over existing photonic crystal designs, as it allows for electrical control over the photonic crystal device without significant absorption of light by the contacts. Although the first and second lateral electrical contacts 102a and 102b are illustrated as being positioned along an edge 112a or 112b of the substrate 104, those skilled in the art will appreciate that the contacts 102 may be placed anywhere on the substrate 104 where they are sufficiently optically isolated from the waveguide region.

Although the embodiment illustrated in FIG. 1 depicts electrical contacts 102 that are separated from a waveguide 108 by three rows of apertures 106, those skilled in the art will appreciate that the invention may be practiced using any number of rows of apertures 106 to optically isolate the contacts 102 from the waveguide 108. The number of apertures 106 necessary to optically isolated the contacts 102 from the waveguide 108 will vary depending on a number of parameters, and in particular on the refractive indices of the photonic crystal substrate 104 and surrounding materials and on the spacing of the apertures 106, as well as the diameter of the apertures 106. The combination of the refractive index contrast and the spacing and the size of the apertures 106 defines the position of the photonic bandgap (i.e., the range of frequencies of the light that will not be transmitted by the photonic crystal structure 100).

For example the size (i.e., diameter) of the apertures 106 and the spacing therebetween is chosen to place the photonic band gap of the photonic crystal structure 100 at a desired frequency of operation. The size and spacing of the apertures depends directly on the refractive indices of the materials forming the photonic crystal structure 100. In one embodiment, the photonic crystal structure 100 is a two-dimensional structure formed from a silicon substrate 104 and having apertures 106 filled with air. The spacing between the apertures 106 is approximately 445 nm, with a ratio of aperture-radius-to-spacing of 0.25-to-0.35. The thickness of the substrate 104 is normalized to the spacing and is 0.5 to 0.6 times as great as the spacing. The photonic band gap is centered at a wavelength of approximately 1.5 μm. In this embodiment, the contacts 102 are spaced from the waveguide 108 by three to six rows of apertures 106.

In one embodiment, the electrical contacts 102 are ohmic contacts formed by doping contact areas on the substrate 104 with a dopant 202 (such as boron, phosphorous or arsenic, among others), and then depositing a metal layer (such as titanium, gold, tungsten, tantalum, palladium or ruthenium, among others) 204 on top of the dopant 202. In one embodiment, the doping concentration for forming the contacts 102 is in the range of about 10¹⁹ to 10²⁰. In another embodiment, a silicide contact is formed on top of the dopant 202 by depositing a metal (such as nickel, cobalt or titanium, among others) that is later annealed to form a metal silicide. A voltage may then be applied over the contacts 102, and a current will be generated through the waveguide 108. In one embodiment, the dopant concentration is controlled to give an appropriate resistivity that will induce resistive heating, enabling thermo-optic control of the waveguide 108. That is, a phase change in the optical signal passing through the waveguide 108 can be introduced or removed by sequentially heating and cooling the substrate 104. The doping concentration in this case could also be, for example, about 10¹⁹ to 10²⁰.

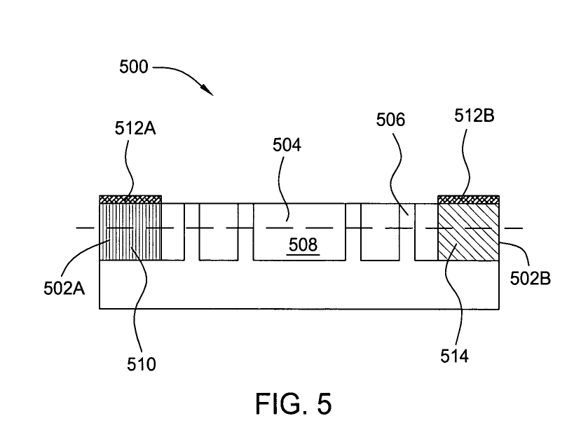

FIG. 5 is a cross sectional view of another embodiment of a photonic crystal structure 500 according to the present invention, in which contacts 502a and 502b are oppositely doped. The photonic crystal structure 500 is substantially similar to the structure 100 illustrated in FIGS. 1 and 2 and comprises a substrate 504, a plurality of apertures 506 formed through the substrate 504, a waveguide 508, and first and second electrical contacts 502a and 502b.

The first contact 502a comprises a p-doped layer 510 and a metal contact 512a disposed over the p-doped layer 510. The second contact 502b comprises an n-doped layer 514 and a metal contact 512b disposed over the n-doped layer 514. Thus each side of the waveguide 508 is oppositely doped. In one embodiment, the waveguide region itself is undoped. In another embodiment, the waveguide region is lightly doped.

In one embodiment, a forward bias is applied to the contacts 502a and 502b, to induce a current that results in carrier injection. A photonic crystal structure 500 such as that illustrated may be particularly well suited for applications involving high frequency switching, as many conventional substrate materials (including Si, and SiGe, among others) tend to exhibit a change in refractive index with a change in carrier concentration. In another embodiment, a reverse bias is applied to the contacts 502a and 502b to enable the photonic crystal structure 500 to function as a waveguide photodetector. If the substrate 504 is formed of a material that is absorbing at an illuminated wavelength, carriers are generated via the photoelectric effect when light passes through the waveguide 508. An electric field in the waveguide sweeps the photo-generated carriers between the contacts 502a and 502b generating a current.

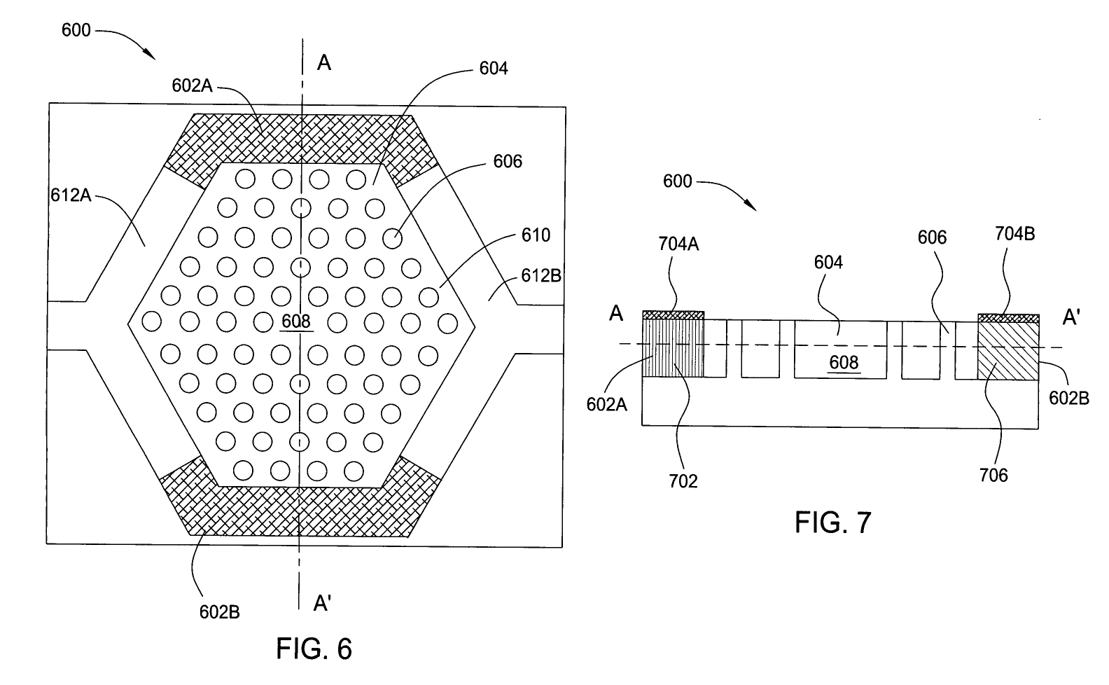

FIG. 6 is a top plan view of another embodiment of a photonic crystal device 600 in which the device 600 is constructed as a resonant cavity. The photonic crystal device 600 is substantially similar to the photonic crystal devices 100 and 500 described with reference to the preceding Figures, and comprises a substrate 604, a plurality of apertures 606 formed through the substrate 604, a waveguide 608, and first and second electrical contacts 602a and 602b. In contrast to the embodiments illustrated in the preceding Figures, the contacts 602a and 602b are not entirely linear, but rather wrap around a portion of the perimeter 610 of the substrate 604, which in one embodiment is shaped as a hexagon. The waveguide 608 is not formed as a channel, but is instead formed as a cavity (i.e., apertures 606 are “removed” from the center of the substrate 604 to form a waveguide 608 that is surrounded around it perimeter by apertures 606) that confines light. In one embodiment, the photonic crystal device includes first and second trenches 612a and 612b (hereinafter collectively referred to as “trenches 612”) that surround the portions of the substrate perimeter that are not adjacent to the contacts 602a and 602b. The trenches 612 substantially prevent charges from traveling the easiest possible route for thermo-optic applications.

As illustrated by FIG. 7, which is a cross sectional view of the photonic crystal device 600 illustrated in FIG. 6 taken along line A-A′, the contacts 602a and 602b are oppositely doped. The first contact 602a comprises a p-doped layer 702 and a metal contact layer 704a disposed over the doped layer 702. The second contact 602b comprises an n-doped layer 706 and a metal contact layer 704b disposed over the doped layer 706.

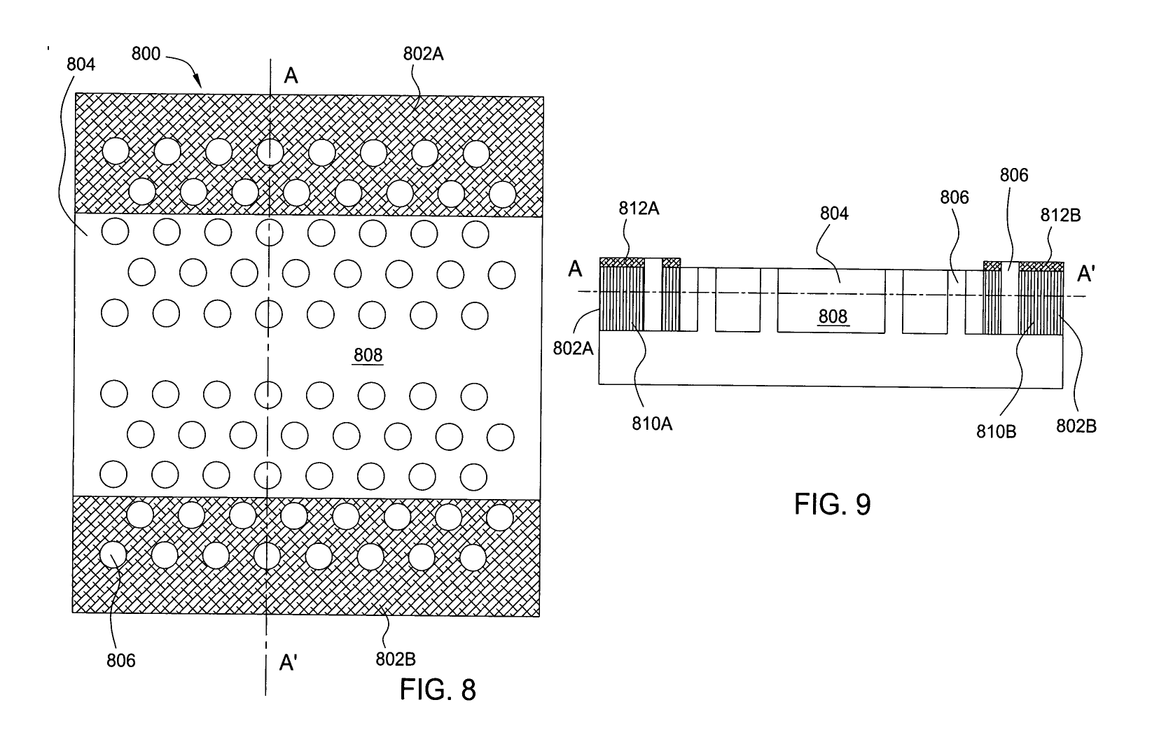

FIG. 8 is a top plan view of another embodiment of a photonic crystal device 800 in which the apertures 806 extend into the contact area. The photonic crystal device 800 is substantially similar to the photonic crystal devices 100 and 500 described with reference to the preceding Figures, and comprises a substrate 804, a plurality of apertures 806 formed through the substrate 804, a waveguide 808, and first and second electrical contacts 802a and 802b (hereinafter collectively referred to as “contacts 802”). In contrast to the embodiments illustrated in the preceding Figures, some of the plurality of apertures 806 extend into the region of at least one of the contacts 802 and actually extend vertically through the contacts 802. The extension of the apertures 806 into the contact region enhances the optical isolation of the contacts 802 without having to move the contacts 802 any further away laterally from the waveguide 808.

In one embodiment, the apertures 806 are formed in the substrate 804 all the way to the edges, and a mask opening is made in a chemical resist to expose the contact areas. The exposed contact areas are then doped by accelerating doping atoms to the substrate 804; the doping atoms are incorporated only into the areas where openings have been made in the chemical resist mask (i.e., the exposed contact areas). Deposition of metal layers over the doped layers may be achieved in a similar manner.

In one embodiment illustrated by FIG. 9, which is a cross sectional view of the photonic crystal device 800 illustrated in FIG. 8 taken along line A-A′, the contacts 802a and 802b are doped. Each contact 802 comprises a doped layer 810a or 810b (hereinafter collectively referred to as “doped layers 810”) and a metal contact layer 812a or 812b disposed over the doped layer 810. As in the preceding embodiments, the contacts 802 may be doped with the same material, or, alternatively, the contacts 802 may be oppositely doped, where, for example, the doped layer 810a is p-doped and the doped layer 810b is n-doped. Alternatively, an asymmetric configuration may be constructed by doping one contact and leaving the other contact substantially undoped.

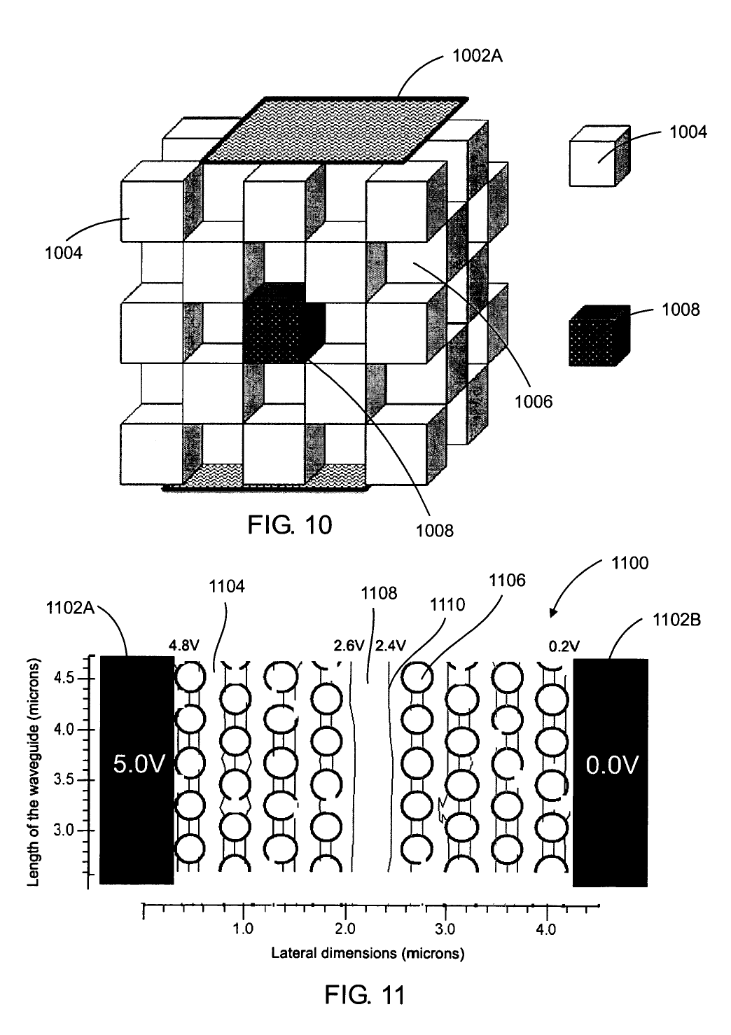

FIG. 10 is a plan view of one embodiment of a three-dimensional photonic crystal structure 1000 having lateral electrical contacts 1002a and 1002b (hereinafter collectively referred to as “contacts “1002”) according to the present invention. The three-dimensional structure 1000 comprises unit cells 1004 and 1006 comprising high refractive index elements (1004) and low refractive index elements (1006) and a waveguide 1008. In one embodiment, the low refractive index elements (or unit cells) 1006 are hollow spaces distributed throughout the structure 1000 (i.e., comparable to the apertures discussed with respect to the two-dimensional structures). The waveguide 1008 is formed as a cavity that localizes or confines light so that the intensity of the light mode decays exponentially with distance from the waveguide 1008. In another embodiment, the waveguide 1008 is formed as a channel that allows light to propagate in one direction while still confining the light in other directions. The contacts 1002 may be formed in a manner similar to the contacts described herein with reference to the preceding Figures, and in one embodiment, the contacts 1002 are positioned at least one unit cell away from the waveguide 1008.

Thus, optical isolation of light is achieved by confining the light to the region of the waveguide 1008 so that it does not attenuate in the contacts 1002. At the same time, the contacts 1002 are close enough to the waveguide 1008 to provide sufficient current and/or electric field strength for applications including, but not limited to, the modulation of the refractive index of the waveguide 1008, or to inject or collect carriers in the region of the waveguide 1008.

Thus, the present invention represents a significant advancement in the field of photonic crystal devices. Lateral electrical contacts are provided that supply electrical current to the photonic crystal structure, allowing for active control over the photonic crystal properties. The placement of apertures to optically isolate a waveguide from the electrical contacts confines light laterally within the waveguide region, minimizing losses due to absorption that might otherwise occur due to the lateral placement of the contacts.

While foregoing is directed to the preferred embodiment of the present invention, other and further embodiments of the invention may be devised without departing from the basic scope thereof, and the scope thereof is determined by the claims that follow.

1. An apparatus comprising:
a photonic crystal having a layer where light is guided or is confined; and
at least one lateral electrical contact coupled to said layer of the photonic crystal.

2. The apparatus of claim 1, wherein the photonic crystal is a two-dimensional structure comprising:
a substrate;
a plurality of apertures formed through the substrate; and
a waveguide for guiding said light, wherein the waveguide is formed in said layer and is positioned proximate to the plurality of apertures.

3. The apparatus of claim 1, wherein the photonic crystal is a three-dimensional structure comprising:
a plurality of high refractive index elements;
a plurality of low refractive index elements distributed throughout the high refractive index elements; and
a region located within the photonic crystal where said light is confined.

4. The apparatus of claim 2, wherein the at least one lateral electrical contact comprises:
a first lateral electrical contact positioned proximate to the waveguide, where the first lateral electrical contact is optically isolated from the waveguide by the plurality of apertures; and
a second lateral electrical contact positioned proximate to the waveguide, where the second lateral electrical contact is optically isolated from the waveguide by the plurality of apertures.

5. The apparatus of claim 4, wherein the first and second lateral electrical contacts are metallic.

6. The apparatus of claim 5, wherein the first and second lateral electrical contacts have layers that are at least partially doped.

7. The apparatus of claim 6, wherein the first and second lateral electrical contacts are substantially identically doped.

8. The apparatus of claim 6, wherein the first and second lateral electrical contacts are oppositely doped.

9. The apparatus of claim 8, wherein the first lateral contact is p-doped and the second lateral contact is n-doped.

10. The apparatus of claim 2, wherein the waveguide is formed as a channel through the plurality of apertures.

11. The apparatus of claim 2, wherein the waveguide is formed as a cavity disposed substantially in the center of the plurality of apertures.

12. The apparatus of claim 2, wherein the substrate in a region of the waveguide is lightly doped.

13. The apparatus of claim 2, wherein the substrate is formed from a material having a high refractive index.

14. The apparatus of claim 2, wherein the substrate material comprises at least one of silicon, carbon, germanium, gallium arsenide, gallium phosphide, indium phosphide, indium arsenide, indium antimonide, zinc oxide, zinc sulfide, cadmium sulfide, cadmium selenide, cadmium tellurium, and alloys thereof.

15. The apparatus of claim 4, wherein some of the plurality of apertures are formed through at least one of the first and second lateral electrical contacts.

16. The apparatus of claim 1, wherein the apparatus is an optical delay line.

17. The apparatus of claim 1, wherein the apparatus is an optical modulator.

18. The apparatus of claim 1, wherein the apparatus is a photodetector.

19. The apparatus of claim 1, wherein the apparatus is a thermo-optic switch.

20. The apparatus of claim 1, wherein the apparatus is a free-carrier injection switch.

21. A method for applying electrical control to a photonic crystal structure comprising:
providing a photonic crystal having a layer where light is guided;
coupling at least one lateral electrical contact to said layer of the photonic crystal; and
applying a voltage to the at least one lateral electrical contact.

22. The method of claim 21, wherein the step of providing the photonic crystal comprises:
providing a substrate;
forming a plurality of apertures through the substrate; and
forming a waveguide for guiding said light, wherein the waveguide is formed in said layer and is positioned proximate to the plurality of apertures.

23. The method of claim 22, wherein the step of coupling at least one lateral electrical contact to said layer of the photonic crystal comprises:
placing a first lateral electrical contact proximate to the waveguide, where the first lateral electrical contact is substantially optically isolated from the waveguide by the plurality of apertures; and
placing a second lateral electrical contact proximate to the waveguide, where the second lateral electrical contact is substantially optically isolated from the waveguide by the plurality of apertures.

24. The method of claim 23, wherein the steps of placing the first and second lateral electrical contacts further comprises:
doping at least a portion of the first and second lateral electrical contacts.

25. The method of claim 24, wherein the first and second lateral electrical contacts are substantially identically doped.

26. The method of claim 24, wherein the first and second lateral electrical contacts are oppositely doped.

27. The method of claim 26, wherein the step of applying a voltage over the first and second lateral electrical contacts comprises:
applying a forward bias to the contacts.

28. The method of claim 26, wherein the step of applying a voltage over the first and second lateral electrical contacts comprises:
applying a reverse bias to the contacts.

29. The method of claim 22, wherein the step of forming a waveguide comprises:
forming the waveguide as a channel through the plurality of apertures.

30. The method of claim 22, wherein the step of forming a waveguide comprises:
forming the waveguide as a cavity disposed substantially in the center of the plurality of apertures.

31. The method of claim 23, wherein some of the plurality of apertures are formed through at least one of the first and second lateral electrical contacts.

32. A method for thermo-optic control of a photonic crystal structure comprising:
providing a photonic crystal comprising:
a substrate;
a plurality of apertures formed through the substrate; and
a waveguide formed through the plurality of apertures, substantially proximate to the middle of the substrate;
forming a first lateral electrical contact proximate to the waveguide, the first lateral electrical contact being optically isolated from the waveguide by the plurality of apertures;
forming a second lateral electrical contact proximate to the waveguide, the second lateral electrical contact being optically isolated from the waveguide by the plurality of apertures; and
sequentially heating and cooling the substrate.

33. The method of claim 32, wherein the steps of forming the first and second lateral electrical contacts comprise:
forming a dopant layer proximate to the first and second edges of the substrate;
depositing a metal over the dopant layer.

34. The method of claim 32, wherein the steps of forming the first and second lateral electrical contacts comprise:
forming a dopant layer proximate to the first and second edges of the substrate;
depositing a silicide contact over the dopant layer.

35. The method of claim 32, wherein the step of sequentially heating and cooling the substrate comprises:
applying a voltage over the first and second lateral electrical contacts.

36. The method of claim 32, wherein some of the plurality of apertures are formed through the first and second lateral electrical contacts.
